(19) United States
(12) Patent Application Publication
(10) Pub. No.: US 2006/0183001 A1
(43) Pub. Date: Aug. 17, 2006

(54) Data support application of data to be kept and method for application of data to be kept secret to a data support

(76) Inventor: Reinhold Uhlemayr, Rutesheim (DE)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 10/558,953

(22) PCT Filed: Jun. 11, 2004
(86) PCT No.: PCT/EP04/06284

§ 371 Date: Nov. 30, 2005

(30) Foreign Application Priority Data
Jun. 20, 2003 (DE) 103 27 666.1

(51) Int. Cl. G11B 5/33

(52) U.S. Cl. 428/800

(57) ABSTRACT

The invention relates to a data support for application of data to be kept secret, including a support layer (1) on which the data to be kept secret is to be printed and a cover layer (2), at least partly covering the support layer (1), for covering the printed data. According to the invention, the data security for such a data support may be improved, whereby the support layer (1) or the cover layer (2) is made from a porous sheet material. The invention further relates to a method for application of data to be kept secret on such a data support.

The invention relates to a data carrier for application of data to be kept secret according to the preamble of Claim 1, and also to a method for applying data to be kept secret onto such a data carrier.

Data to be kept secret, such as, for example, access codes, PIN numbers for activating debit or credit cards, PUK numbers for cellular phone applications, or TAN numbers for online banking, are usually sent from the sender to the receiver using special data carriers that are to guarantee that only the receiver can learn information from the data to be kept secret. For this purpose, various data carriers and also methods for applying the data to be kept secret onto this data carrier are known from the state of the art. For example, carbonless copying papers are used in which mechanical pressure breaks open ink capsules, which then trigger inking reactions with a reactive counter layer. These reactions make the data to be kept secret visible on a bottom layer. The data visible on the surface of the bottom layer is covered by the copying paper lying on top and can be viewed only by removing the copying paper. The surface of the copying paper is usually provided with a blackout area in order to prevent the data from showing through. In the method for applying the data to be kept secret onto this carbonless copying paper, up to four sheets must be connected to each other through overall adhesion. Furthermore, it is necessary that special printers, for example impact printers, must be provided for printing of the data, which results in additional expense in terms of cost and logistics. A document for transmitting secret data with a multipart form set is described, for example, in DE 197 47 818 A1.

Furthermore, data carriers are known from the state of the art in which the data to be kept secret is covered by a rub-off coating and is revealed by rubbing off this coating. For applying the data to be kept secret, a smooth paper substrate is printed on, for example, with a laser printer, and the printed area is then covered with a clear coating and finally with the rub-off layer. In these data carriers there is not always data security, because at first the printed information remains visible immediately after printing until it is covered by the subsequent coating step. In addition, the method for applying the data onto these data carriers results in high costs, because several coatings are necessary, and an expensive coating device must be provided. Such data carriers and methods for applying data to be kept secret onto these data carriers are described, for example, in DE 101 50 136 A1 and DE 197 33 876 A1.

Starting with the disadvantages of the data carriers known from the state of the art and methods for applying data to be kept secret onto such data carriers, the invention is based on the problem of providing a data carrier which is economical in production and which improves the data security. Another problem of the invention is to present an economical and efficient method for applying data to be kept secret onto such a data carrier.

These problems are solved with a data carrier with the features of Claim 1 and also with a method with the features of Claim 20. Advantageous configurations of the data carrier and preferred embodiments of the method follow from the subordinate claims.

The invention is explained in more detail below with reference to the associated drawings using embodiments. The drawings show:

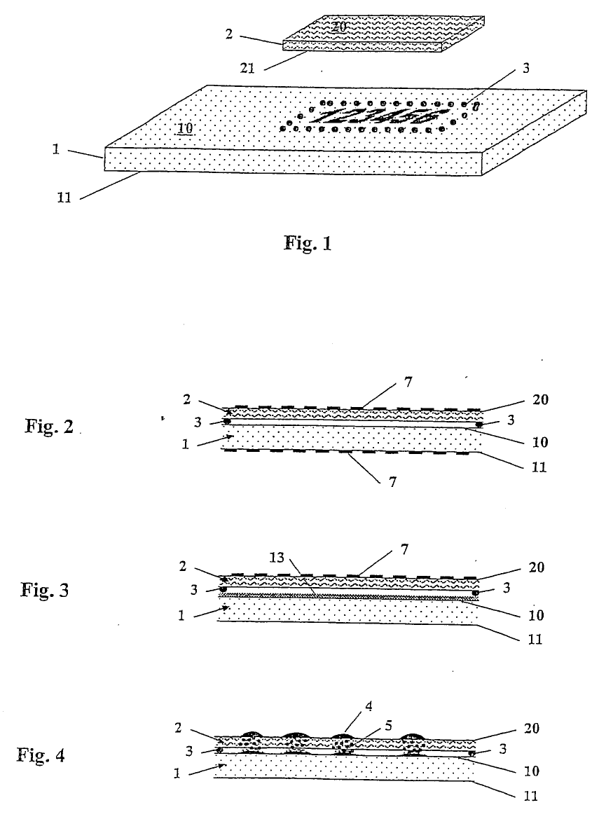

FIG. 1: exploded view of the basic structure of a data carrier according to the invention;

FIG. 2: cross section through the layer structure of an embodiment of the data carrier according to the invention;

FIG. 3: cross section through the layer structure of another embodiment of the data carrier according to the invention;

FIG. 4: schematic representation of an intermediate stage of the method for applying data to be kept secret onto a data carrier according to FIG. 2;

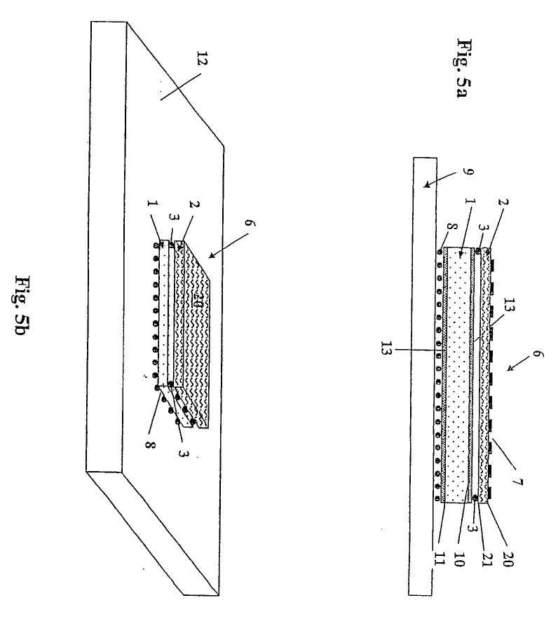

FIG. 5: schematic representation of another embodiment of the data carrier according to the invention, which is embodied here as a self-adhesive label.

A first embodiment of the data carrier according to the invention comprises a first layer 1 and a second layer 2, which are adhered to each other over their entire surface or at least at the periphery along a continuous circumferential adhesive strip 3. The first layer 1 is used as the carrier layer 1 and the second layer is used as the cover layer 2, which overlaps the first layer 1 at least in one partial area. The cover layer 2 features a top, blank surface 20 and a bottom surface 21 facing the carrier layer 1. The carrier layer 1 accordingly features a top surface 10 facing the cover layer 2 and a bottom surface 11 forming the back side of the data carrier.

The carrier layer 1 involves a paper layer. The cover layer 2 is formed by a porous sheet body, especially by a porous composite textile material. Preferably, the porous sheet body involves an open pore nonwoven material, e.g., a polyester fiber nonwoven material or a mixture of polyester fibers with cellulose, for example, a mixture of 80% polyester fibers and 20% cellulose. The nonwoven material preferably features a weight per unit area of 8 to 800 g/m², and especially preferably between 8 and 35 g/m². Alternatively, the porous sheet body can also be a felt material or a nonwoven material made from synthetic or semi-synthetic fibers, such as, e.g., nylon or rayon or a mixture of these materials.

The data to be kept secret is applied to this data carrier laminate structure with the carrier layer 1 and the cover layer 2, in that the data carrier is fed to a printer, for example, a laser printer.

In FIG. 4, an intermediate stage of the method for applying the data to be kept secret onto the data carrier by means of a laser printer is shown. For applying the data, first the toner particles 5 are deposited onto the free surface 20 of the cover layer 2 facing away from the first layer 1 at high pressure and high temperatures, e.g., in the range of ca. 200° C. Due to the permeability of the cover layer 2, the toner particles 5 penetrate into the cover layer 2, pass through this cover layer completely, and reach the surface 10 of the carrier layer 1 facing the cover layer 2. In order for the toner particles 5 to pass through the cover layer 2 as much as possible, as in a screening process, it is necessary for the toner particles 5 to be smaller than the pores of the porous sheet body. Because typical particle sizes of common toners are on the order of magnitude of a few μm, the cover layer 2 is preferably formed by a porous material with open pores with a pore size of greater than 20 μm. Such materials feature an air permeability of at least 100 dm³/gm² measured according to DIN 53 923. Preferably, nonwoven materials or felts with an air permeability of approximately 1000 dm³/gm² are used.

By cooling to room temperature, the toner 4 on the surface 10 of the carrier layer 1 is fixed there in order to form the printing of the data to be kept secret.

For applying the data onto the data carrier, all printing methods are suitable in which, very generally, particles 5 of a printing medium 4 are deposited onto a substrate to be printed on. Thus, as described above, it can involve a thermal transfer printing method or a laser printing method, in which toner particles 5 are deposited onto a substrate to be printed on at high pressure and high temperature and then fixed on the substrate through cooling.

As an alternative to the thermal transfer printing method or the laser printing method, an inkjet printing method can also be used for applying the data. Here, at first the ink 4 is likewise deposited onto the blank surface 20 of the cover layer 2. Due to the porosity of the cover layer 2, the ink penetrates into the interior of the cover layer 2 and passes completely through this cover layer in order to finally reach the surface 10 of the carrier layer 1 and there, after drying, forms the data imprint.

The data printed on the surface 10 of the carrier layer 1 according to the described method is covered completely by the top layer acting as the cover layer 2, both during the printing method and also after the printing method, and therefore it cannot be viewed. The data carrier printed with the data to be kept secret can then be sent in this form to the receiver together with an associated letter. By removing the cover layer 2, the receiver can expose and view the data printed on the surface 10 of the carrier layer 1 and covered at first by this cover layer. Thus, to a large extent it is guaranteed that unauthorized persons cannot learn information from the contents of the data to be kept secret without visibly damaging the data carrier.

In order to guarantee that the particles 5 (toner particles or ink droplets) of the printing medium 4 (toner or ink) pass through the cover layer 2 as much as possible without leaving particles 5 on the blank surface 20, the carrier layer 1 is preferably provided with a coating which attracts the particles of the printing medium. In the use of a thermal transfer method or a laser printing method, a polyvinyl acetate coating, for example, is suitable as a toner-philic coating. An oliophilic coating of the carrier layer 1 has also proven to be suitable for this purpose. Preferably, the toner-philic or oliophilic coating involves a heat sealing material which is fused to the carrier layer 1, over its entire area or only a partial area, under pressure and at high temperatures. In addition to the fusing under pressure and at high temperatures, ultrasound energy can be emitted onto the edge in order to enable an even better adhesive fusing of the coating onto the carrier layer.

In order to fulfill the same purpose, the cover layer 2 can be saturated with a toner-repellent (or anti-adhesive) fluid, for example, with Teflon® (polytetrafluoroethylene) or with a fluid wax. The anti-adhesive fluid has the effect that the toner particles 5 do not remain fixed in the cover layer 2, whereby the transfer of the toner 4 from the blank surface 20 of the cover layer 2 to the surface 10 of the carrier layer 1 is accelerated and made easier. The same effect is caused by a wax-like coating of the cover layer 2, because the transport of the toner particles is accelerated by such a coating under pressure and high temperatures, in that the wax-like coating, on one hand, causes a thinning of the toner 5 and an improvement of the flowability and, on the other hand, provides for a faster heat transport and thus for a faster and more efficient transport of the toner particles 5 through the cover layer 2.

For the use of an inkjet printing method for applying the data onto the surface 10 of the carrier layer 1, a hydrophilic cover layer is preferably used, because in this way, the transport of the ink through the cover layer 2 is accelerated and thus more efficient.

In FIG. 2, a preferred embodiment of the data carrier is shown in a sectional view. The data carrier comprises a carrier layer 1 and a cover layer 2 formed by a porous nonwoven material. These layers are adhered to each other over their entire surface or at least at the edges. The data to be kept secret is printed onto the surface 10 of the carrier layer 1 with a printing method as described above. In order to prevent the printed data from becoming visible, especially with the use of backlighting, an interference print 7 is printed both on the blank surface 20 of the cover layer 2 and also on the blank surface 11 of the carrier layer 1. This interference print 7 can involve, for example, a sea of numbers or a totally black printed area.

In FIG. 3, another embodiment of the data carrier is shown. This embodiment differs from the embodiment shown in FIG. 2 in that the interference print 7 on the blank surface 11 of the carrier layer 1 is not present and that instead of this print, the surface 10 of the carrier layer 1 is provided with a metallic coating 13, e.g., an aluminum coating. On the one hand, the metallic coating 13 prevents the data printed on the surface of the metal layer 13 from showing through. On the other hand, the metal layer 13 also improves the transfer of the toner particles 5 when the data is printed by means of a thermal transfer method, because the metal layer 13 heats up quickly first and therefore contributes to a rapid and complete passage of the toner particles 5 through the cover layer. As an alternative to the metallic coating of the surface 10 of the carrier layer 1, a metal foil can also be provided which is arranged between the carrier layer 1 and the cover layer 2. In another embodiment-here not represented in a drawing-both surfaces 10, 11 of the carrier layer 1 can be provided with a metallic coating or a metal foil 13.

In order to guarantee the simplest possible handling of the data carrier according to the invention, the data carrier is preferably formed as a self-adhesive label 6, as shown in FIG. 5a. For this purpose, the layer structure of the data carrier is coated with a self-adhesive glue 8 on its back side, thus the blank surface 11 of the carrier layer 1, and adhered onto a silicon carrier paper 9. For fixing the data carrier, this self-adhesive label 6 adhered to the silicon carrier paper 9 is fed to a printer in order to print the data to be kept secret as described above. Then the self-adhesive label 8 is pulled from the silicon carrier paper 9 and adhered to a form carrier 12 with the self-adhesive glue 8 remaining on the blank surface 11 of the carrier layer 1. The transfer of the data carrier formed as a self-adhesive label 6 from the silicon carrier paper 9 onto the form carrier 12 is realized by means of known label dispensing machines. Here, the form carrier 12 preferably represents the letter of the sender to the receiver, with which the data to be kept secret is sent.

In another embodiment, not represented in a drawing here, the data carrier according to the invention comprises, in turn, a first layer 1, which here is opaque and is used as a cover layer, and a second layer 2, which is adhered to the first layer at the edges and which is formed by a porous sheet body and used as the carrier layer. Here, the data to be kept secret is applied mirror-reversed to the blank surface 20 of the second layer 2. In this embodiment, however, at least a portion of the particles 5 of the printing medium 4 does not penetrate the second layer 2 completely, but instead remains in the vicinity or on the surface 21 of the second layer 2 facing the first layer 1, and there forms the data imprint. Here, it is important that the particles 5 of the printing medium 4, for example, the toner particles 5, penetrate far into the interior of the second layer 2, so that no more particles 5 remain on or in the vicinity of the blank surface 20 of the second layer, because otherwise the data would be visible on the blank surface 20.

In order to learn information from the data printed according to this method, the receiver pulls the second layer 2 from the first layer 1. To simplify the removal, peripheral perforations are stamped into the second layer 2, along which the second layer 2 can be torn off. The data to be kept secret can then be read on the bottom surface 21 of the second layer 2. To prevent the printed data from showing through, in this embodiment the blank surface 20 of the second layer 2 is provided with an interference print, for example, a sea of numbers, and the back side of the data carrier, thus the free surface 11 of the first layer 1, is provided with an opaque coating, e.g., a metallic coating or a painted coating. Preferably, a metallic coating 13 or a metal film can also be provided between the first layer 1 and the second layer 2.

Compared with the solutions known from the state of the art, the data carrier according to the invention is advantageous in that conventional printing methods can be used, whereby additional investment and maintenance costs for expensive printers can be saved. Furthermore, the conventional systems used for creating letters, including conventional postal processing production lines, can also be used. In addition, absolute confidentiality is guaranteed, because the data is covered at all times, thus both during and also after printing, and can be viewed only by destroying the data carrier, namely by separating the cover layer 2 from the carrier layer 1.

1. Data carrier for applying data to be kept secret, with a carrier layer (1) on which the data to be kept secret is to be printed, and with a cover layer (2) which at least partially covers the carrier layer (1) and which is to cover the printed data, characterized in that the carrier layer (1) or the cover layer (2) is formed by a porous sheet body.

2. Data carrier according to claim 1, characterized in that the sheet body has open pores.

3. Data carrier according to claim 1, characterized in that the cover layer (2) is formed by a porous nonwoven material and the cover layer is made from paper or a film material.

4. Data carrier according to claim 3, characterized in that the carrier layer (1) is provided with a metallic coating (13) or with a metal film on one side or on both sides.

5. Data carrier according to claim 1 characterized in that the cover layer (2) is formed by a porous nonwoven material and the carrier layer (1) is formed by a metal film, especially an aluminum film.

6. Data carrier according to claim 1 characterized in that the cover layer (2) is formed by a porous nonwoven material and that the carrier layer (1) has multiple layers with a metal film (13) as the layer facing the cover layer (2).

7. Data carrier according to claim 6 characterized in that the surface (20) of the cover layer (2) facing away from the carrier layer (1) is printed with an interference print (7), especially a sea of numbers.

8. Data carrier according to claim 3, characterized in that a toner-philic coating, for example, polyvinyl acetate, and/or an oliophilic coating, is deposited on the carrier layer (1).

9. Data carrier according to claim 3, characterized in that the cover layer (2) is saturated with a toner-repellent fluid, for example, with polytetrafluoroethylene.

10. Data carrier according to claim 3, characterized in that the cover layer (2) is provided with a wax-like coating.

11. Data carrier according to claim 3, characterized in that the nonwoven material is made from polyester fibers or from a mixture of polyester fibers with cellulose or from synthetic or semi-synthetic fibers or from a mixture of these materials.

12. Data carrier according to claim 3, characterized in that the nonwoven material is made from a mixture of 80% polyester fibers and 20% cellulose.

13. Data carrier according to claim 4, characterized in that the nonwoven material features a weight per unit area of between 8 to 100 g/m², preferably between 20 and 35 g/m².

14. Data carrier according to claim 13, characterized in that the carrier layer (1) and the cover layer (2) are adhered to each other peripherally at the edges or over their entire area.

15. Data carrier according to claim 14, characterized in that the cover layer (2) is provided with perforations in order to allow the data hidden under the cover layer (2) to be made visible by tearing away at the perforations.

16. Data carrier according to claim 15, characterized in that the cover layer (2) is hydrophilic.

17. Data carrier according to claim 1, characterized in that the carrier layer (1) is formed by a nonwoven material and that the cover layer (2) is opaque.

18. Data carrier according to claim 17, characterized in that data to be kept secret is printed on the top side (10) of the carrier layer (1) facing the cover layer (2).

19. Data carrier according to claim 18, characterized in that the data carrier is formed as a self-adhesive label (6), which features on its bottom side an adhesive coating (8) with which it is adhered onto a carrier film (9).

20. Method for applying data to be kept secret onto a data carrier, characterized by the following steps:
providing a still unprinted data carrier with a first layer (1) and a second layer (2) made from a porous sheet body,
applying the data onto the blank surface (20) of the second layer (2) facing away from the first layer (1) by means of a printing method, in which particles (5) of a printing medium (4) are deposited onto a substrate to be printed on, with the particles (5) of the printing medium (4) passing through the second layer and reaching the surface (21) of the second layer (2) facing the first layer (1) and/or reaching the surface (10) of the first layer (1) lying underneath, in order to form the data imprint there.

21. Method according to claim 20, characterized in that the printing method is a thermal transfer printing method, a laser printing method, or an inkjet printing method.

22. Method according to claim 20, characterized in that the particles (5) of the printing medium (4) are deposited at temperatures of 180° C. to 220° C. and then fixed by cooling.

23. Method according to claim 20, characterized in that the particles (5) of the printing medium are smaller than the pores of the porous sheet body.

24. Method according to claim 20, characterized in that the data is deposited mirror-reversed onto the blank surface (20) of the second layer (2).
